(19) United States
(12) Patent Application Publication
(10) Pub. No.: US 2006/0213903 A1
(43) Pub. Date: Sep. 28, 2006

(54) DRINK MAKER

(76) Inventor: Chuan-Min Lin, Kao-Hsiung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/276,965

(22) Filed: Mar. 20, 2006

(30) Foreign Application Priority Data
Mar. 24, 2005 (TW) 094109125

(51) Int. Cl. H05B 6/80

(52) U.S. Cl. 219/689

(57) ABSTRACT

A drink maker uses a sensor connected to a stirrer to transmit a temperature signal to a control chip, and compares the temperature signal to a predetermined temperature. If the temperature transmitted from the sensor reaches the predetermined temperature, the drink maker will stop. In addition, the drink maker can be started or stopped by pressing a switch. The drink maker can also be connected to a mobile device to provide more convenience and portability.

### BACKGROUND OF INVENTION

1. Field of the Invention

The present invention relates to a drink maker, and more specifically, to a drink maker capable of controlling a stirrer according to a temperature measured by the stirrer.

2. Description of the Prior Art

Modern society is characterized by convenience and efficiency. In such a world, the simple pleasure of a hot drink is something that can be enjoyed by many. A wide variety of options exist to satisfy hot drink lovers, such as homemade hot drinks in thermos bottles, hot coffee from vending machines, and cafes on every street.

In general, a heating apparatus is needed to heat the drink to an acceptable temperature for drinking. Cooking facilities and insulated holders such as thermos flasks are regularly used, and hot drinks purchased outside employ the same methods. The main limitation of these heating apparatuses is that they can only operate in a fixed place, and are rarely designed to be portable. Furthermore, even those heating devices designed to be portable are too large to be carried conveniently. Therefore, portable drink makers were developed, which heat the drinks based on friction caused by stirring. These portable drink makers are mostly in the shape of long rods. To heat drinks, the rod is placed in the liquid and rotated, causing friction which heats the drink. These prior art drink makers use batteries to supply the necessary power for driving their motors.

There are two problems inherent in this design. Firstly, the prior art drink maker needs an additional power supply; this power supply element adds to the size of the drink maker and increases the cost of production. Secondly, the prior art drink maker leaves the temperature control up to the user's instinct, which is an ineffective method of controlling the heating to an ideal temperature. People will need to test out the drink maker many times before they can effectively gauge whether a desired temperature has been reached. Additionally, external factors such as outside temperature and season will affect the time taken to heat a drink. Therefore, the prior art drink maker has the problem of temperature detection and temperature control of hot drinks, plus the additional problem of power supply for the rotational control of the stirrer.

### SUMMARY OF INVENTION

Therefore, the primary objective of the present invention is to provide a drink maker capable of controlling a stirrer according to the temperature measured by the stirrer to solve the above-mentioned problem.

The present invention provides a drink maker. The drink maker comprises a stirrer, a sensor for measuring a sensing temperature, and a motor for driving the stirrer to stir, and for stopping the stirrer when the sensing temperature measured by the sensor reaches a predetermined temperature.

The present invention also provides an electronic device capable of stirring drinks. The electronic device comprises a housing, an expansion port installed on the housing for connecting a drink maker, and a logic chip for generating a control command, which controls the motor to drive the stirrer to stir.

The present invention also provides a portable device capable of stirring drinks. The portable device comprises a drink maker, and an electronic device. The drink maker comprises a stirrer, a sensor for measuring a sensing temperature, a motor for driving the stirrer to stir, and a connection port. The electronic device comprises a housing, an expansion port installed on the housing for connecting the drink maker, and a logic chip for generating a control command, which controls the motor to drive the stirrer to stir, and generating a stop signal, which controls the motor to stop the stirrer when the sensing temperature measured by the sensor reaches a predetermined temperature.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates the present invention drink maker.

FIG. 2 is a functional diagram of the drink maker in FIG. 1.

FIG. 3 is a functional diagram of the sensor in FIG. 2.

FIG. 4 illustrates the present invention electronic device capable of stirring drinks.

FIG. 5 is a functional diagram of the electronic device in FIG. 4.

FIG. 6 illustrates the present invention portable device capable of stirring drinks.

FIG. 7 is a functional diagram of the portable device in FIG. 6.

### DETAILED DESCRIPTION

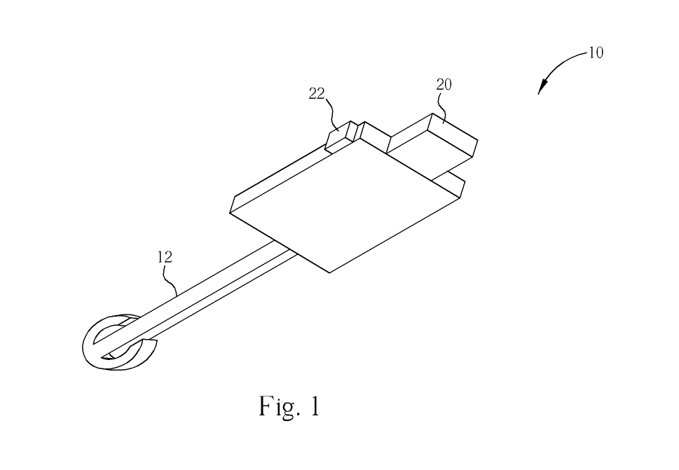

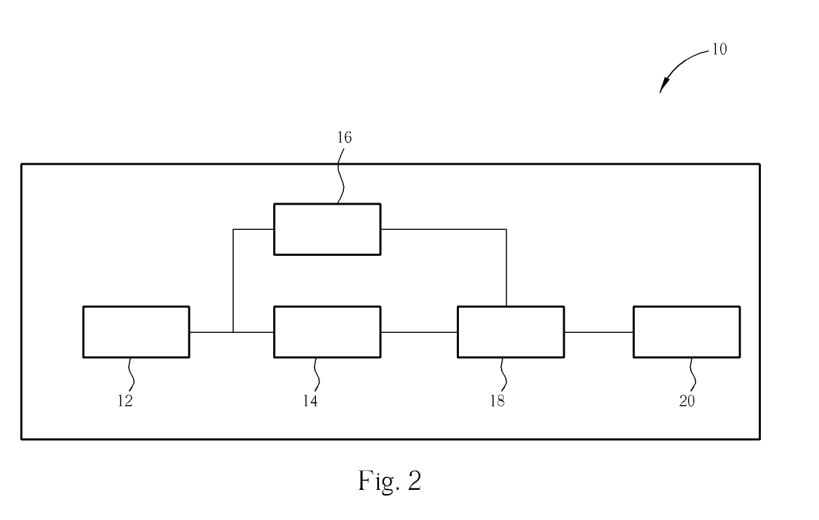

Please refer to FIG. 1 and FIG. 2. FIG. 1 illustrates the present invention drink maker 10. FIG. 2 is a functional diagram of the drink maker 10. The drink maker 10 comprises a stirrer 12, a sensor 16, a motor 14, a control chip 18, a connection port 20, and a switch 22. When heating drinks by stirring, the stirrer 12 of the drink maker 10 is placed in the liquid and stirred in a rotational manner. The motor 14 coupled with the control chip 18 drives the stirrer 12 to rotate and, due to the friction force between the stirrer 12 and the liquid, the liquid is heated. The motor 14 is driven by the control chip 18 to rotate or stop, and the control chip 18 also controls the speed of rotation of the motor 14.

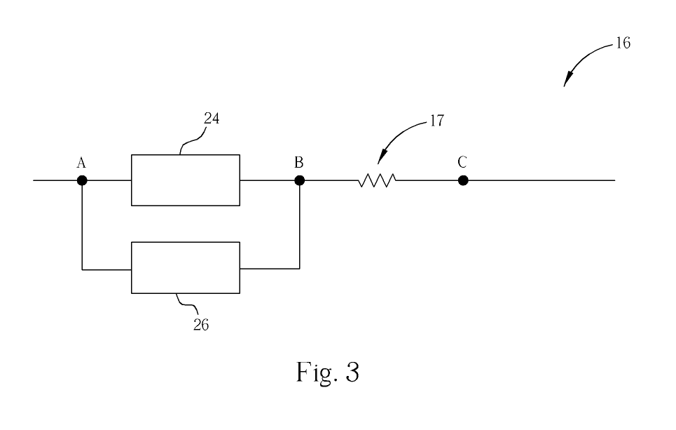

Please refer to FIG. 3 for a functional diagram of the sensor 16. When the stirrer 12 stirs and heats the liquid, the sensor 16 coupled with the stirrer 12 of the drink maker 10 will use the stirrer 12 to obtain a sensing temperature. The sensor 12 comprises a negative temperature resistance 24, a capacitance 26 and a resistance 17 connected in series with the negative temperature resistance 24. The present invention drink maker 10 uses the negative temperature resistance 24 to sense the temperature of the liquid. When an endpoint A, which is connected with the stirrer 12, receives the temperature from the stirrer 12, the impedance of the negative temperature resistance 24 decreases as the temperature increases. The temperature of the endpoint A and an endpoint B is the temperature of the stirrer 12. Using voltage division principle, a voltage value in accordance with the change of the temperature of the stirrer 12 is measured at an endpoint C. The endpoint C is connected with an analog integrated circuit, and through an analog-to-digital converter (ADC) of the analog integrated circuit, the voltage signal is converted to a digital signal and transmitted to an electronic device through the connection port 20. A display can be installed on the electronic device for displaying the measured temperature from the drink maker 10.

Additionally, the drink maker 10 can also operate according to a predetermined temperature. Please refer to FIG. 2 again. When the sensing temperature measured by the sensor 16 exceeds a predetermined temperature, the control chip 18 generates and transmits a control signal to the motor 14, controlling the motor 14 to stop the stirrer 12. In a practical operation, the control signal does not have to be generated by the control chip 18. For design simplicity, the control chip 18 can transmit the sensing temperature from the sensor 16 to the electronic device, and then the electronic device compares the sensing temperature from the control chip 18 with a predetermined temperature, and sends a control command (a stop signal) to stop the motor 14 once the sensing temperature has reached the predetermined temperature.

A switch 22 is further installed on the drink maker 10 for activating the motor 14 to drive the stirrer 12. The motor 14 can also be activated by another switch on the electronic device. The motor 14 can be a brush motor or any other motor device that is able to drive the stirrer 12. Practically, the drink maker 10 can be a coffee maker. The present invention motor stirrer combination can therefore support a wide variety of hot drinks, for example, the foamed milk of a cappuccino coffee.

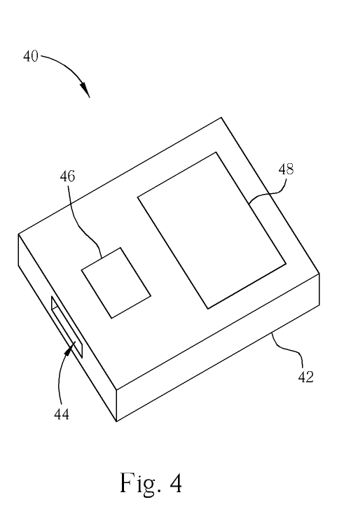

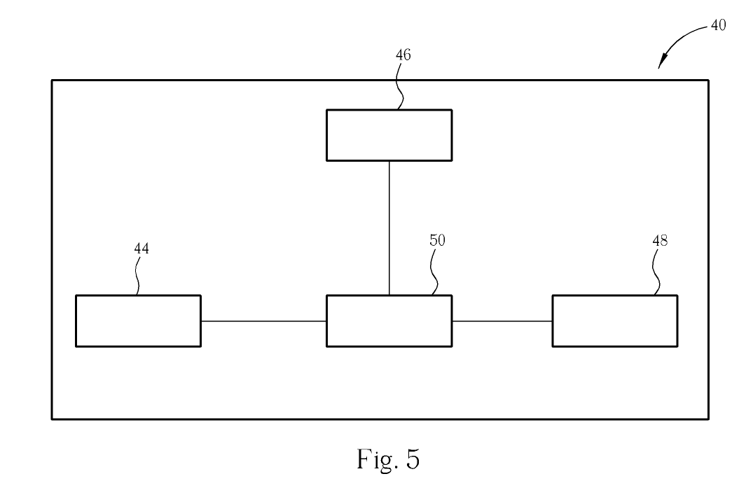

Please refer to FIG. 4 and FIG. 5. FIG. 4 is an illustration of the present invention electronic device 40 capable of stirring drinks. FIG. 5 is a functional diagram of the electronic device 40 in FIG. 4. The electronic device 40 comprises a housing 42, an expansion port 44 installed on the housing 42, a switch 46, a logic chip 50, and a display 48. As FIG. 4 shows, the expansion port 44 is for connecting a drink maker, which is detachably connected to the housing 42 through the expansion port 44. The switch 46 is for activating a motor of the drink maker to drive a stirrer of the drink maker when the electronic device 40 is powered on, or for stopping the stirrer when the stirrer is operating. The logic chip 50 is for generating a control command, which controls the motor of the drink maker to drive the stirrer of the drink maker to stir. The display 40 is for displaying the control command generated by the logic chip 50 and a sensing temperature measured by a sensor of the drink maker.

Similar to the drink maker 10 in FIG. 1 and FIG. 2, the logic chip 50 of the electronic device 40 can further generate a control command (a stop signal) to control the motor to stop the stirrer when the sensing temperature measured by the sensor of the drink maker reaches a predetermined temperature. Additionally, the electronic device 40 can be a mobile device, or more specifically, a mobile phone. The switch 46 installed on the electronic device 40 can be a separate button for controlling the motor, or any established button on the mobile phone. The present invention electronic device 40 can also use a touch screen installed on the housing 42 of the electronic device 40 (wherein the touch screen is the display 48) instead of the switch 46, to activate or stop the drink maker, where the predetermined temperature and a rotational speed can be set up by the switch 46. The expansion port 44 is a 10-pin I/O connector. The display 48 can be a mono super twisted nematic (MONO STN) display, a super twisted nematic (STN) display, a thin film transistor liquid crystal display (TFT-LCD), a low temperature poly-silicon (LTP) display, or an organic light emitting display (OLED).

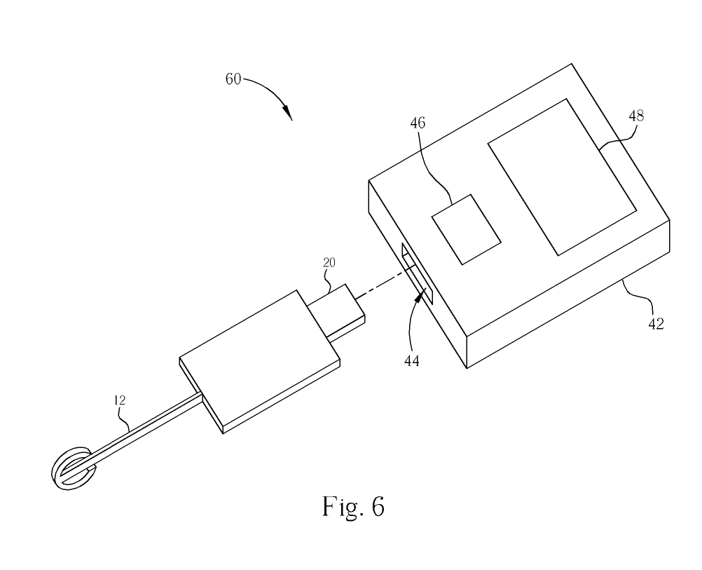

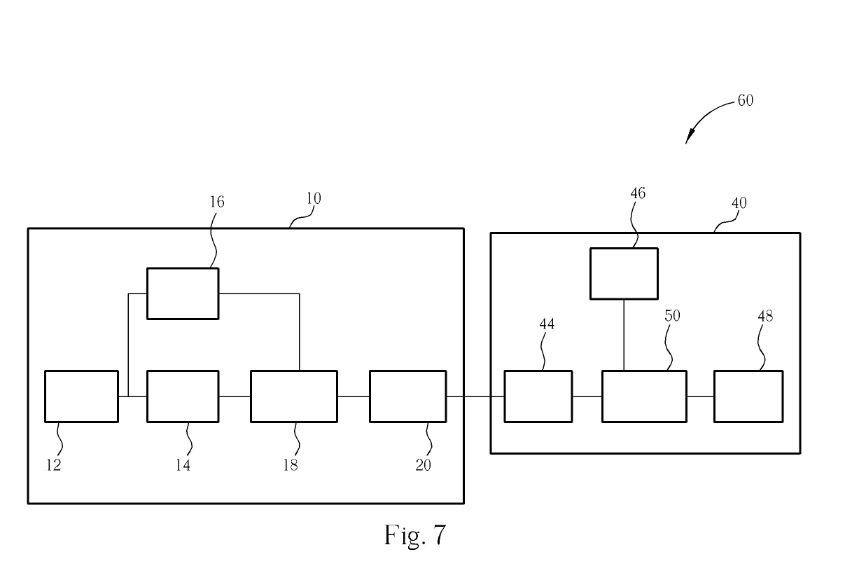

Finally, please refer to FIG. 6 and FIG. 7. FIG. 6 is an illustration of the present invention portable device 60 capable of stirring drinks. FIG. 7 is a functional diagram of the portable device 60 in FIG. 6. The portable device 60 comprises a drink maker 10 and an electronic device 40. The drink maker 10 comprises a stirrer 12, a motor 14, a sensor 16, a control chip 18, and a connection port 20. The electronic device 40 comprises a housing 42, an expansion port 44, a switch 46, a display 48, and a logic chip 50. The drink maker 10 of the portable device 60 is detachably electrically connected to the expansion port 44 of the electronic device 40 through the connection port 20. When using the portable device 60 to make drinks, the switch 46 of the electronic device 40 is pressed, causing the logic chip 50 to generate a control command. The logic chip 50 transmits the control command to the control chip 18 through the expansion port 44 and the connection port 20. Finally, the control chip 18 controls the motor 14 to drive the stirrer 12 to rotationally stir the liquid.

The portable device 60 is further provided with the function of temperature sensing and controlling. The drink maker 10 further comprises a sensor 16 for measuring a temperature of the stirrer 12. The control chip 18 then converts the sensing temperature to a digital signal and transmits the digitized sensing temperature signal to the logic chip 50 through the connection port 20 and the expansion port 44. When the sensing temperature measured by the sensor 16 reaches a predetermined temperature, the logic chip 50 generates a control command and transmits the control command to the control chip 18 through the expansion port 44 and the connection port 20. Once the control chip 18 receives the control command, a stop signal in this situation, the control chip 18 generates a control signal to control the motor 14 to stop the stirrer 12. In the present invention portable device 60, both the predetermined temperature and the rotational speed of the stirrer 12 can be set up by an input interface of the electronic device 40, where the input interface can be the switch 46 or the display 48 (a touch screen) of the electronic device 40.

As the logic chip 50 receives the sensing temperature from the drink maker 10, it compares the sensing temperature with the predetermined temperature and transmits the sensing temperature to the display 48 for displaying. The displaying of the sensing temperature allows users to see the temperature of the heated liquid anytime and the user can press the switch 46 to stop the drink maker 10 at any time of the process. If the user does not stop the drink maker 10 by pressing the switch 46 during the stirring process, the portable device 60 will heat the liquid until the temperature of the liquid reaches a predetermined temperature set by the user, and then the portable device 60 will stop the drink maker 10.

The electronic device 40 can be a mobile device, or more specifically, a mobile phone. The switch 46 installed on the electronic device 40 can be a separate button for controlling the motor, or any established button on the mobile phone. The present invention portable device 60 can also use a touch screen installed on the housing 42 of the electronic device 40 (where the touch screen is the display 48) instead of the switch 46 to activate or stop the drink maker 10. The expansion port 44 is a 10-pin I/O connector. The display 48 can be a mono super twisted nematic (MONO STN) display, a super twisted nematic (STN) display, a thin film transistor liquid crystal display (TFT-LCD), a low temperature poly-silicon (LTP) display, or an organic light emitting display (OLED).

With the present invention drink maker, a user is not only given the convenience of making drinks by plugging the drink maker into a mobile device but also given the freedom to control temperature of the drink according to personal preference. The present invention solves the problem of inaccessibility of hot drinks, making them available at any time and any place.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A drink maker comprising:
a stirrer;
a sensor for measuring a sensing temperature; and
a motor for driving the stirrer to stir and stopping the stirrer when the sensing temperature measured by the sensor reaches a predetermined temperature.

2. The drink maker of claim 1 further comprising a control chip for transmitting the sensing temperature to an electronic device and controlling the motor to drive the stirrer according to a control command from the electronic device.

3. The drink maker of claim 2 wherein the control command is a stop signal for controlling the motor to stop the stirrer when the sensing temperature reaches the predetermined temperature.

4. The drink maker of claim 1 further comprising a switch for activating the motor to drive the stirrer.

5. The drink maker of claim 1 wherein the motor is a brush motor.

6. The drink maker of claim 1 wherein the drink maker is a coffee maker.

7. An electronic device capable of stirring drinks comprising:
a housing;
an expansion port installed on the housing for connecting a drink maker; and
a logic chip for generating a control command to control a motor of the drink maker to drive a stirrer of the drink maker to stir.

8. The electronic device of claim 7 wherein the logic chip further generates a stop signal to control the motor to stop the stirrer when a sensing temperature measured by a sensor of the drink maker reaches a predetermined temperature.

9. The electronic device of claim 8 further comprising a display for displaying the control command and the sensing temperature.

10. The electronic device of claim 7 further comprising a switch for activating the motor to drive the stirrer.

11. The electronic device of claim 7 wherein the electronic device is a mobile device.

12. The electronic device of claim 11 wherein the mobile device is a mobile phone.

13. The electronic device of claim 7 wherein the expansion port is a 10-pin I/O connector.

14. A portable device capable of stirring drinks comprising:
a drink maker comprising:
a stirrer;
a sensor for measuring a sensing temperature;
a motor for driving the stirrer to stir; and
a connection port; and
an electronic device comprising:
a housing;
an expansion port installed on the housing for connecting the drink maker; and
a logic chip for generating a control command to control the motor to drive the stirrer to stir, and generating a stop signal to control the motor to stop the stirrer when the sensing temperature measured by the sensor reaches a predetermined temperature.

15. The portable device of claim 14 wherein the drink maker further comprises a control chip for transmitting the sensing temperature to the logic chip and controlling the motor to drive the stirrer according to a control command from the logic chip.

16. The portable device of claim 14 wherein the electronic device further comprises a switch for activating the motor to drive the stirrer.

17. The portable device of claim 14 wherein the motor is a brush motor.

18. The portable device of claim 14 wherein the drink maker is a coffee maker.

19. The portable device of claim 14 wherein the electronic device is a mobile device.

20. The portable device of claim 19 wherein the mobile device is a mobile phone.

21. The portable device of claim 14 wherein the expansion port is a 10-pin I/O connector.

22. The portable device of claim 14 wherein the electronic device further comprises a display for displaying the control command and the sensing temperature.
